(19) United States
(12) Patent Application Publication
(10) Pub. No.: US 2026/0086106 A1
(43) Pub. Date: Mar. 26, 2026

(54) Component for Measuring Rotational Speed, in Particular for a Vehicle, Method for Producing Such a Component, Detection Device and Vehicle Having Such a Component

(71) Applicant: Bayerische Motoren Werke Aktiengesellschaft, Muenchen (DE)

(72) Inventors: Thomas HUELSS, Muenchen (DE); Joachim MEESS, Ergoldsbach (DE); Moritz WEICKARDT, Muenchen (DE)

(21) Appl. No.: 19/110,280

(22) PCT Filed: Oct. 26, 2023
(86) PCT No.: PCT/EP2023/079919

§ 371 Date: Mar. 10, 2025

(30) Foreign Application Priority Data
Nov. 18, 2022 (DE) 10 2022 130 594.5

(51) Int. Cl. G01P 3/44; G01D 5/20; G01D 5/244

(52) U.S. Cl. CPC G01P 3/44; G01D 5/2013; G01D 5/244; G01D 2205/28; G01D 2205/80

(57) ABSTRACT

The present disclosure relates to a component having a main body that is provided with a coating, wherein the coating has a plurality of coating segments which extend about an axis of rotation of the component extending in the circumferential direction of the component and at least partially spaced apart from one another, by means of which coating segments a rotational speed of the component rotating about the axis of rotation can be detected.

### BACKGROUND AND SUMMARY

The invention relates to a structural element, in particular for a vehicle, according to the preamble of patent claim 1. Furthermore, the invention relates to a method for producing such a structural element. The invention also relates to a detection device, in particular for a vehicle, according to the preamble of patent claim 9. Furthermore, the invention relates to a vehicle, in particular a motor vehicle, having at least one such detection device.

US 9 145 028 B2 discloses a fastening structure of a wheel rotational speed sensor ring. Furthermore, KR 100879592 B1 discloses a drive unit.

It is an object of the present invention to provide a structural element, a method, a detection device and a vehicle, such that rotational speed can be detected in a particularly advantageous manner.

This object is achieved according to forms of the invention by means of a structural element having the features of patent claim 1, by means of a method having the features of patent claim 8, by means of a detection device having the features of patent claim 9 and by means of a vehicle having the features of patent claim 10. The dependent claims provide advantageous refinements of the invention.

A first aspect of the invention relates to a structural element. For example, the structural element may be used for or in a vehicle. It goes without saying that other applications and/or uses of the structural element are readily conceivable. The vehicle is preferably a motor vehicle. The motor vehicle may in particular be a car such as a passenger car. It is also conceivable for the motor vehicle to be a powered cycle, in particular a motorcycle. The powered cycle is for example a single-track motor vehicle with exactly two vehicle wheels. It is also conceivable for the powered cycle to be a tricycle, thus an in particular two-track powered cycle with exactly three vehicle wheels, such that the powered cycle is for example in the form of a motorcycle with a sidecar or in the form of what is known as a trike. The respective vehicle wheel is a respective ground contact element, by way of which the vehicle is supportable or supported in a vehicle height direction of the vehicle downward on the ground. If the vehicle is driven along the ground, while the vehicle is supported in the vehicle height direction downward on the ground by way of the respective ground contact element, the ground contact element rolls, in particular directly, on the ground.

The structural element has a main body which is provided with a coating. For example, the coating is applied to, in particular deposited on, the main body. Thus, the coating is in particular a layer arranged on the main body.

In order to then be able to detect rotational speed in a particularly advantageous manner, the invention provides for the coating to have multiple coating segments which are at least partially, in particular completely, spaced apart from one another in the circumferential direction of the structural element, wherein the circumferential direction of the structural element runs about an axis of rotation of the structural element, that is to say is for example rotatable about the axis of rotation relative to at least one component. In this case, the coating elements can be used to detect, in particular contactlessly and/or magnetically and/or electrically and/or capacitively, a rotational speed of the structural element which is rotatable about the axis of rotation. The component is or comprises, for example, a sensor which is also referred to as rotational speed sensor and can be used to detect the coating segments, in particular contactlessly, that is to say without contact between the sensor and the coating segments, as a result of which the rotational speed of the structural element is detectable. In particular, it is for example possible for the sensor to detect the coating segments, which are also referred to simply as segments, magnetically and/or electrically and/or capacitively, that is to say in that the segments, when the structural element is rotated about the axis of rotation relative to the component and thus relative to the sensor, influence a particular electrical and/or magnetic field which is able to be provided or is provided for example by the sensor. The detection of rotational speed mentioned above should therefore be understood to mean the detection of the rotational speed of the structural element by means of the segments. The rotational speed should be understood to mean a variable which, in the case of rotation of the structural element about the axis of rotation relative to the component, indicates a number of revolutions of the structural element that are effected within a time span about the axis of rotation relative to the component in relation to the mentioned time span, for example in the unit revolutions per minute. The invention thus makes it possible to detect the rotational speed of the structural element in a manner which is particularly favorable in terms of costs and weight. Conventionally, a rotational speed of a structural element is detected in such a way that the structural element has a structure which is in particular mechanical and/or in the form of a solid body, such as a toothing with alternately successive teeth and tooth gaps. It is also conceivable for the structure to have alternately successive cutouts and protrusions that are raised in relation to the cutouts. The mechanical structure can for example be detected capacitively and/or magnetically and/or electrically by means of a rotational speed sensor, in such a way that when the structural element is rotated relative to the rotational speed sensor, the structure influences an electrical and/or magnetic field provided for example by the rotational speed sensor. However, a disadvantage of these conventional solutions is that the structure has to be produced by at least one or more working steps which have to be carried out merely to produce the structure. Furthermore, the mechanical structure is usually not in one piece, that is to say is not formed integrally with the structural element, but rather the structure is usually produced separately from the structural element and connected to the structural element, for example in that the structure is screwed to the structural element. Thus, to produce the structure, a separate, additional production process which for example comprises the working steps and by which the structure is specifically produced is usually necessary. Consequently, conventional solutions for detecting rotational speed are expensive. Furthermore, a structural unit comprising the structural element and the structure which is produced separately from the structural element and connected to the structural element has a high weight. The disadvantages mentioned above can then be avoided by the invention. Since, according to the invention, the coating segments are used to detect the rotational speed of the structural element, and since the main body is provided with the coating, the coating can be produced in a manner which is particularly favorable in tens of time and costs and the main body can be provided with the coating in a manner which is particularly favorable in terms of time and costs, for example in such a way that the coating is applied to the main body. The coating is thus not a part formed separately from the main body, but rather is produced in particular using the main body. Furthermore, the coating can be produced with only low material consumption and thus in a manner which is favorable in terms of time, weight and costs, in particular in that the main body is provided with the coating segments only in certain regions, that is to say only locally and thus only in subregions, wherein further subregions of the main body which for example adjoin the subregions are free from the coating. As a result, the weight, the costs and the installation space requirement of the structural element can be kept within a particularly low scope. Furthermore, it is possible for the main body to be produced from a cost-effective material, which can for example per se, that is to say considered on its own, not be detected by means of the rotational speed sensor and even a structure produced for example from the material could not be detected by the rotational speed sensor, since for example the material is not capable of influencing an electrical and/or magnetic field provided for example by the sensor. However, the coating segments can be detected by the rotational speed sensor. Since, however, the main body can be provided with the coating segments only locally, the material consumption for producing the coating and thus the costs and the weight of the coating per se, that is to say considered on its own, can be kept particularly low, with the result that the costs, the weight and installation space requirement of the structural element can be kept within a particularly low scope overall.

In particular, it is conceivable for the main body to be provided directly with the coating, such that for example the coating is applied directly to the main body. This should in particular be understood to mean that no other, further material is arranged between the main body and the coating.

Since the rotational speed of the structural element can be detected by means of the coating segments, in such a way that the rotational speed sensor can detect the coating segments or an influence that the coating segments have or are able to have on an in particular electrical and/or magnetic field provided for example by the sensor, it is possible to avoid the structural element being provided with or connected to a separate, additionally produced structure provided for rotational speed detection, with the result that the rotational speed of the structural element can be detected in a manner which is particularly favorable in terms of costs and weight. In particular, it is for example possible to avoid separately produced sensor wheels, sensor rings or pulse-generating apertures, in particular punched apertures. Additional connection techniques such as screw connections, in order to connect the structural element to a separately produced structure for rotational speed detection, can also be avoided, with the result that the rotational speed of the structural element can be detected in a manner which is particularly simple and favorable in terms of costs and weight.

In order to be able to detect the rotational speed of the structural element in a particularly simple and precise manner, one embodiment of the invention provides for the coating segments and thus the coating to comprise at least one or exactly one ferromagnetic material, in particular a ferritic material. The ferromagnetic material may, for example, be a metal powder, in particular a ferritic and/or ferromagnetic metal powder. Furthermore, this makes it possible to realize particularly advantageous corrosion resistance of the coating. It is conceivable for the ferromagnetic material, in particular the metal powder, to be embedded in a matrix material. The ferromagnetic material may, for example, influence an in particular electrical and/or magnetic field, which is provided or able to be provided by the rotational speed sensor, in a particularly advantageous manner, in particular when the structural element is rotated about the axis of rotation relative to the rotational speed sensor. This influence on the field can be detected by the rotational speed sensor, as a result of which the rotational speed of the structural element can be detected precisely and in a manner which is simple and favorable in terms of costs and weight.

For example, the main body is or has been provided with the coating and thus with the coating segments by way of a coating method, such that the coating and thus the coating segments are or have been applied to, in particular deposited on, the main body for example by way of the mentioned coating method. The coating method is, for example, a thermal coating method, such that for example the main body is or has been provided with the coating and thus with the coating segments by thermal coating, that is to say by the thermal coating method. Again in other words, for example the coating and thus the coating segments are or have been applied to, in particular deposited on, the main body by the thermal coating, that is to say by the thermal coating method. It is also conceivable for the coating method to be spraying, in particular thermal spraying, such that the coating and thus the coating segments are applied to, that is to say deposited on, the main body for example in such a way that the coating and thus the coating segments are sprayed onto and/or against the main body. Very preferably, the coating method is cold gas spraying (CGS), such that preferably the coating and thus the coating segments are or have been applied to, in particular deposited on, the main body by cold gas spraying. The coating or a coating material from which the coating is or has been produced is in this case for example applied in powder form at a very high speed as a carrier material, which is also referred to as substrate, to the main body. Thus, the coating material is or comprises the aforementioned material and/or the aforementioned ferromagnetic material such as the metal powder.

A further embodiment is distinguished in that the main body is formed from a non-ferromagnetic material. This makes it possible for the costs of the main body and thus of the structural element to be kept particularly low overall, with the result that the rotational speed can be detected in a particularly cost-effective manner.

In order to be able to keep the weight and the costs of the main body and thus of the structural element within a particularly low scope overall, a further refinement of the invention provides for the main body to be formed from a plastic, which is thus preferably the aforementioned non-ferromagnetic material.

A further, particularly advantageous embodiment of the invention provides for the main body to be formed from a first material, wherein the coating segments are formed from a second material which differs from the first material. This makes it possible for the costs and the weight of the structural element to be kept particularly low, with the result that rotational speed detection which is particularly favorable in terms of costs and weight is feasible.

In order to be able to detect the rotational speed particularly precisely and thus in a particularly advantageous manner, a further refinement of the invention provides for the segments to be spaced apart from one another equally in pairs in the circumferential direction running about the axis of rotation, thus to be uniformly distributed.

A further, particularly advantageous embodiment of the invention provides for the structural element to be a rim for the aforementioned vehicle and thus a constituent part of at least one of the vehicle wheels of the vehicle. When the vehicle comprising the structural element is in a completely produced state, a tire, formed in particular from rubber, of the at least one vehicle wheel is for example pulled onto the rim, such that the tire is connected to the rim. Thus, the rim comprises the main body and the coating, with the result that the rotational speed can be detected in a manner which is particularly favorable in terms of costs and weight. In conventional solutions, in particular in the case of conventional powered cycles, the rotational speed is detected in such a way that a detection element which is formed separately from a rim and is for example in the form of a sensor ring or sensor wheel is used and rotationally conjointly connected, for example by screws, to the rim, wherein the detection element can be used to detect the rotational speed. By contrast, the invention enables rotational speed detection which is significantly favorable in terms of weight and costs.

The rotational speed sensor may, for example, provide an in particular electrical signal which characterizes, that is to say indicates, the detected rotational speed of the structural element and is also referred to as rotational speed signal. In particular when the structural element is in the form of the mentioned rim, the rotational speed is a rotational speed of the at least one vehicle wheel, such that the rotational speed is also referred to as wheel rotational speed. The detected rotational speed or the signal characterizing the rotational speed may, for example, be used for an anti-lock braking system (ABS), for example in order to avoid locking of the vehicle wheel when the vehicle wheel is braked. In particular when the structural element is the mentioned rim, the unsprung mass of the vehicle can be reduced in comparison to conventional solutions.

It has furthermore been shown to be particularly advantageous if the structural element is a housing for a vehicle, in particular for a transmission of a vehicle, or the structural element is for example a gearwheel for a vehicle, in particular for a transmission of the vehicle. The invention makes it possible to avoid the use of separate structures for rotational speed detection, with the result that the rotational speed can be detected in a manner which is particularly favorable in terms of weight and costs. The transmission is, for example, a differential transmission, which is also referred to simply as differential.

A second aspect of the invention relates to a method for producing a structural element according to the first aspect of the invention. Advantages and advantageous refinements of the first aspect of the invention are considered to be advantages and advantageous refinements of the second aspect of the invention and vice versa.

Thus, the method for example comprises the coating method by means of which the main body is provided with the coating and thus with the coating segments, in particular in such a way that the coating and thus the coating segments are applied to, in particular deposited on, the main body in the coating method. In the coating method, the coating is for example applied to the main body in such a way that the coating or the aforementioned coating material from which the coating is produced is sprayed onto and/or against the main body. In particular, the coating method is a spraying method. The coating material is or comprises, for example, the ferromagnetic material, in particular the metal powder, which is for example applied in powder form to the main body, in particular is sprayed against the main body.

A third aspect of the invention relates to a detection device, in particular for a vehicle. The detection device according to the third aspect of the invention has at least one sensor which is also referred to as rotational speed sensor. Furthermore, the detection device according to the third aspect of the invention comprises at least one structural element which is rotatable about an axis of rotation relative to the sensor. The sensor can be used to detect, in particular contactlessly and/or magnetically and/or electrically and/or capacitively, a rotational speed of the structural element in particular with respect to the axis of rotation. The feature that the sensor can be used to detect the rotational speed of the structural element with respect to the axis of rotation should in particular be understood to mean that the sensor can detect a number of revolutions of the structural element that are effected within a time span about the axis of rotation relative to the sensor in particular in relation to the time span, wherein the rotational speed characterizes, that is to say indicates or describes, the number of detected rotations in relation to the time span.

In order to then be able to detect the rotational speed of the structural element in a manner which is particularly favorable in terms of costs and weight, the third aspect of the invention provides for the structural element to have a main body which is provided with a coating which has a plurality of coating segments which are at least partially, in particular completely, spaced apart from one another in the circumferential direction of the structural element that runs about the axis of rotation of the structural element and are detectable, in particular contactlessly and/or magnetically and/or electrically and/or capacitively, by means of the sensor for the purpose of detecting the rotational speed. Due to the fact that the sensor can contactlessly detect the rotational speed on the basis of the coating segments, it should be understood that the sensor can detect the rotational speed without contact occurring between the sensor and the coating segments or between the sensor and the structural element. Advantages and advantageous refinements of the first aspect and of the second aspect of the invention are considered to be advantages and advantageous refinements of the third aspect of the invention and vice versa.

A fourth aspect of the invention relates to a vehicle which is preferably in the form of a land vehicle and/or motor vehicle and has at least one detection device according to the third aspect of the invention. Advantages and advantageous refinements of the first aspect, of the second aspect and of the third aspect of the invention are considered to be advantages and advantageous refinements of the fourth aspect of the invention and vice versa.

### BRIEF DESCRIPTION OF THE DRAWING

FIG. 1 is a schematic perspective view of a vehicle with a detection device for rotational speed detection.

### DETAILED DESCRIPTION OF THE DRAWING

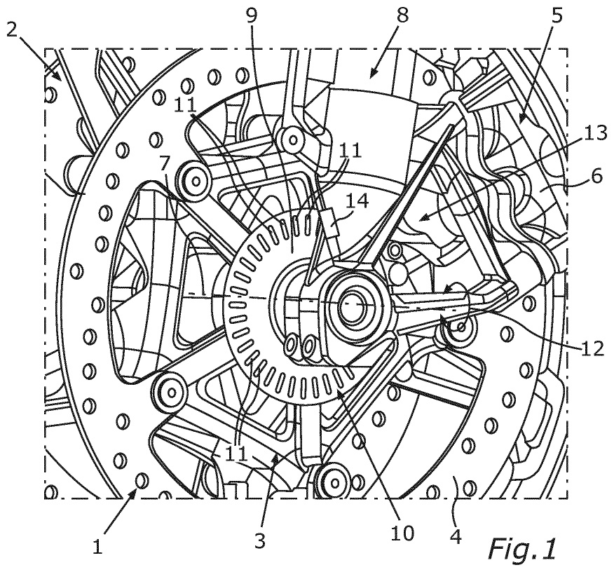

Further details of the invention will become apparent from the description below of a preferred exemplary embodiment with the associated drawing. Here, the single FIG. 1 shows part of a schematic perspective view of a vehicle with a detection device for rotational speed detection.

FIG. 1 shows part of a schematic perspective view of a vehicle 1 which is in the form of a motor vehicle and is in the form of a powered cycle in the exemplary embodiment shown in FIG. 1. In the exemplary embodiment shown in FIG. 1, the powered cycle is a motorcycle which in the present case is in the form of a single-track vehicle with exactly two vehicle wheels which are arranged one behind the other in the vehicle longitudinal direction of the vehicle and are also referred to simply as wheels. In FIG. 1, part of one of the vehicle wheels is visible and denoted by 2. The vehicle wheel 2 is a front wheel, such that the other, second vehicle wheel is a rear wheel. The vehicle wheels are ground contact elements by way of which the vehicle is supportable or supported in the vehicle height direction of the vehicle downward on the ground. If the vehicle is driven along the ground, while the vehicle is supported in the vehicle height direction downward on the ground by way of the ground contact elements, the ground contact elements (vehicle wheels) roll, in particular directly, on the ground. The vehicle wheel 2 has a rim 3 which is a first structural element or is also referred to as first structural element. The vehicle wheel 2 furthermore comprises, for example, a tire which is not visible in FIG. 1, is for example formed from rubber and is also referred to as vehicle tire. The vehicle tire is a second structural element or is also referred to as second structural element. The tire is formed separately from the rim 3 and pulled onto the rim 3 and thereby connected to the rim 3. What is also visible in FIG. 1 is part of a brake disk 4 of a service brake 5, in the form of a disk brake, of the vehicle 1. The service brake 5 also comprises a brake caliper 6. The brake disk 4 is rotationally conjointly connected to the vehicle wheel 2, such that the vehicle wheel 2 and thus the vehicle 1 overall can be braked by means of the service brake 5.

The vehicle wheel 2 and thus the rim 3 are held on the component 8 so as to be rotatable about an axis of rotation 7 relative to a further component 8 of the vehicle 1. The component 8 is in the present case a steering device, in particular a fork, which is for example held so as to be steerable and thus pivotable on a frame of the vehicle 1, the frame not being visible in FIG. 1. If the component 8 and thus the vehicle wheel 2 are pivoted and thus steered relative to the frame, cornering, lane changes and changes in the direction of travel of the vehicle 1 can be brought about hereby. If the vehicle 1 is driven along the ground, while the vehicle 1 is supported in the vehicle height direction downward on the ground by way of the vehicle wheels, the vehicle wheel 2 rolls, in particular directly, on the ground, and in so doing the vehicle wheel 2 rotates about the axis of rotation 7, which is also referred to as wheel axis of rotation, relative to the component 8 and relative to the frame. It can thus be seen that the rim 3 (first structural element) is rotatable about the axis of rotation 7 relative to the component 8 (component). In particular, the vehicle wheel 2 and thus the rim 3 can rotate at different rotational speeds about the axis of rotation 7 relative to the component 8. In order to for example be able to ascertain, in particular detect, a speed of the vehicle 1, which is also referred to as driving speed, it is desirable to detect the respective rotational speed of the vehicle wheel 2, which is also referred to as wheel rotational speed. As an alternative or in addition, it is for example possible for at least one assistance system such as an anti-lock braking system (ABS) of the vehicle 1 to be operated, in particular regulated, in dependence on the detected wheel rotational speed (rotational speed of the vehicle wheel 2), in order to thereby be able to realize particularly safe operation of the vehicle 1.

In order to then be able to detect the rotational speed of the rim 3 and thus of the vehicle wheel 2 in a particularly advantageous manner, in particular in a manner which is particularly favorable in terms of costs and weight, the rim 3 has a main body 9 which is provided with a coating 10 which has a plurality of coating segments 11 which are spaced apart from one another in the circumferential direction of the rim 3, the circumferential direction running about the axis of rotation 7, and by means of which the rotational speed of the rim 3 and thus of the vehicle wheel 2 is detectable. The circumferential direction of the rim 3, the circumferential direction running about the axis of rotation 7, is illustrated in FIG. 1 by a double-headed arrow 12. Preferably, the coating segments 11, which are also referred to simply as segments, are spaced apart from one another equally in pairs in the circumferential direction of the rim 3, as a result of which the rotational speed can be precisely detected.

The coating 10 and thus the coating segments 11 are for example constituent parts of a detection device 13 which is illustrated particularly schematically in FIG. 1 and can be used to detect the rotational speed. The detection device 13 for example also comprises a sensor 14 which is illustrated particularly schematically in FIG. 1, is also referred to as rotational speed sensor or wheel rotational speed sensor and can be used to detect, in particular contactlessly and/or magnetically and/or electrically and/or capacitively, the coating segments 11 and consequently the rotational speed of the rim 3 and thus of the vehicle wheel 2. In particular, it is for example possible for the sensor 14 to provide an in particular magnetic and/or electrical field. If the vehicle wheel 2 and thus the rim 3 and thus the coating segments 11 are rotated about the axis of rotation 7 relative to the component 8 and thus relative to the sensor 14 which is for example held on the component 8, the coating segments 11 influence the field, in particular in that the coating segments 11 are spaced apart from one another in the circumferential direction and in that, in the circumferential direction, between coating segments 11 which are adjacent in the circumferential direction, the main body 9 is free from the coating 10. The sensor 14 can detect the influence that the coating segments 11 have on the field, and thus the rotational speed. The sensor 14 can provide an in particular electrical signal which characterizes the detected rotational speed and on the basis of which the speed can be ascertained and/or the assistance system can be operated, in particular regulated. The sensor 14 can thus detect the rotational speed without the sensor 14 contacting the rim 3, the main body 9 or the coating 10. In this case, the rotational speed can be detected without the rim 3 being provided with a detection element which is formed separately and connected to the rim 3, such as a sensor wheel or a sensor ring.

The coating 10 is or has been applied to, in particular deposited on, the main body 9 for example by cold gas spraying (CGS), such that the main body 9 can be provided with the coating 10, thus with the coating segments 11, in a manner which is particularly favorable in terms of time and costs. Furthermore, the weight of the vehicle wheel 2 and thus the unsprung mass of the vehicle I can be kept particularly low.

For example, the coating segments 11 are formed from a coating material which is also referred to simply as material and is also referred to as first material. The main body 9 is for example formed from a second material, wherein it is conceivable for the second material to be a material which differs from the first material. The coating material (first material) is, for example, a ferromagnetic material or the coating material comprises a ferromagnetic material, wherein the ferromagnetic material may, for example, be or comprise a metal powder.

### LIST OF REFERENCE SIGNS

1 Vehicle
2 Vehicle wheel
3 Rim
4 Brake disk
5 Service brake
6 Brake caliper
7 Axis of rotation
8 Component
9 Main body
10 Coating
11 Coating segment
12 Double-headed arrow
13 Detection device
14 Sensor

1-10. (canceled)

11. A structural element, having a main body which is provided with a coating, where the coating comprises:
a plurality of coating segments, where the coating segments are at least partially spaced apart from one another in a circumferential direction of the structural element that runs about an axis of rotation of the structural element and by means of which a rotational speed of the structural element, which is rotatable about the axis of rotation, is detectable.

12. The structural element of claim 11, wherein the coating segments comprise a ferromagnetic material.

13. The structural element of claim 11, wherein the main body is formed from a non-ferromagnetic material.

14. The structural element of claim 11, wherein the main body is formed from a plastic.

15. The structural element of claim 11, wherein the main body is formed from a first material and the coating segments are formed from a second material which differs from the first material.

16. The structural element of claim 11, wherein the coating segments are spaced apart equally from one another in pairs in the circumferential direction.

17. The structural element of claim 11, wherein the structural element is a rim or a housing or a gearwheel for a vehicle.

18. A method for producing a structural element according to claim 11.

19. A detection device, having at least one sensor, and having at least one structural element which is rotatable about an axis of rotation relative to the sensor and the rotational speed of which is detectable by means of the sensor,
wherein the structural element has a main body which is provided with a coating which has a plurality of coating segments which are at least partially spaced apart from one another in a circumferential direction of the structural element that runs about the axis of rotation of the structural element and are detectable by means of the sensor for the purpose of detecting the rotational speed.

20. A vehicle, having at least one detection device according to claim 19.
